(19) United States
(12) Patent Application Publication
(10) Pub. No.: US 2003/0226939 A1
(43) Pub. Date: Dec. 11, 2003

(54) Grommet connector

(76) Inventors: Jeremy M. Beck, Chicago, IL (US); Kenneth S. Dobson, Chicago, IL (US); Robert K. Dutzi, Palatine, IL (US); Jason K. Trotter, Des Plaines, IL (US)

Correspondence Address: PAUL F. DONOVAN, ILLINOIS TOOL WORKS INC., 3600 WEST LAKE AVENUE, GLENVEIW, IL, 60025, US

(21) Appl. No.: 10/454,184

(22) Filed: Jun. 4, 2003

Related U.S. Application Data
(60) Provisional application No. 60/386,824, filed on Jun. 7, 2002.

(51) Int. Cl. F16L 5/00

(52) U.S. Cl. 248/56

(57) ABSTRACT

A grommet connector including a first end portion and a second end portion with a barrier extending therebetween. The first end portion is adapted for connecting to a grommet, and the second end portion is adapted for connecting to another part, such as a second grommet, a nut or the like to form a subassembly of the grommet and the other part.

### CROSS-REFERENCE TO RELATED APPLICATIONS

This Non-Provisional Application claims benefits to U.S. Provisional Application No. 60/386,824 filed Jun. 7, 2002.

### FIELD OF THE INVENTION

The present invention relates to a connector device for a grommet and, more particularly, the invention relates to a grommet connector useful in the automotive industry for strut mount assemblies and other steering and suspension assemblies.

### BACKGROUND OF THE INVENTION

Strut mount and other suspension system components in an automobile frequently have relatively complex assemblies with numerous individual parts and components. For example, U.S. Pat. No. 5,449,193 entitled “End Link For A Vehicle Stabilizer Bar” shows a relatively complex assembly of washers, numerous grommets, spacers and nuts all assembled on a connector bar. While the individual pieces are not complex units or difficult to manipulate during assembly, the overall assembly becomes complex from the large number of individual pieces assembled on a relatively short bar. Complexity and difficulty in assembly also results from the need to assemble the numerous components not only in proper sequence, but also in the proper end-to-end orientation. These needs require the assembler to pay close attention to the order of assembly and the orientation of each part, to ensure that all components have been properly installed. Assembling the components improperly, such as by forgetting components, installing the components in a wrong sequence or installing the components in the proper sequence but in a wrong end-to-end orientation can impair the performance of the assembly. Thus, it is desirable to reduce the number of components to insure proper assembly.

Even if all components are arranged in proper sequence, and in proper end-to-end orientation, it is difficult to align each on the bar. Slight twisting or misalignment from true axial alignment can also affect ultimate performance of the assembly. Holding the parts, to prevent skewing of spacers, grommets or other parts is difficult because of the numerous parts required in the assembly. Further, assembly is slowed as the assembler is required to obtain, orient and install a large number of separate pieces.

What is needed in the art is a connector device for joining grommets to one or more other adjacent components in such assemblies, to create one or more subassemblies, reduce the number of discrete parts requiring final assembly and to improve and ensure proper alignment and orientation of the parts.

### SUMMARY OF THE INVENTION

The present invention provides a grommet connector that serves as an interconnecting component between a grommet and other assembly parts such as nuts, washers or other grommets, to reduce the number of individual parts requiring final assembly.

In one form thereof, the present invention provides a connector for joining a grommet having an axial grommet hole to an other part also having an axial hole therethrough. The connector has a body with a first end portion and a second end portion. The first end portion is adapted for connection to the grommet and for alignment with the hole of the grommet. The second end portion is adapted to align with the hole in the other part and to connect the connector to the other part. A barrier is disposed between the first end portion and the second end portion. In a preferred embodiment, the barrier comprises a radially extending flange having a diameter larger than the hole of the grommet and larger than the hole of the other part.

In another form thereof, the present invention provides a grommet sub-assembly for a vehicle suspension system with a grommet, an other part and a grommet connector interconnecting the grommet and the other part. The grommet connector includes a first end portion and a second end portion. The first end portion is adapted to engage the grommet and to axially align the connector with a hole in the grommet. The second end portion is adapted to engage the other part and to axially align the connector with a hole in the other part. A barrier is disposed between the first end portion and the second end portion. The barrier is preferably a radially extending flange.

In still another form thereof, the present invention provides a grommet connector for connecting and aligning a grommet having a grommet hole with an other part having a hole. The grommet connector has a barrel-like first end portion adapted for insertion into the grommet hole and for engaging the material of the grommet defining the grommet hole. A second end portion of the connector is adapted to align with the hole in the other part and for connecting the connector to the other part. A barrier is disposed between the first end portion and the second end portion. In one embodiment, the barrier comprises a radially extending flange having a diameter larger than the hole of the grommet.

An advantage of the present invention is providing a connector that can join a grommet to a nut, washer, another grommet or other part to thereby reduce the number of individual parts required in a suspension system final assembly.

Another advantage of the present invention is providing a connector for a grommet and other parts of a suspension system assembly, which promotes proper axial alignment of the parts connected thereby.

Still another advantage of the present invention is providing a grommet connector that is easy to use and install, and that improves durability and performance of the parts.

A further advantage of the present invention is providing a grommet connector that improves assembly efficiency by establishing a modular construction utilizing subassemblies.

A still further advantage of the present invention is providing a grommet connector that can be used to connect a grommet to a variety of different parts, and can be provided in a variety of different connection constructions.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an elevational view of a tension strut assembly having a grommet connector in accordance with the present invention;

FIG. 2 is an elevational view of the grommet connector, grommet and parts connected thereto shown in FIG. 1;

FIG. 3 is a perspective view of a second embodiment of a grommet connector in accordance with the present invention;

FIG. 4 is a perspective view of a third embodiment of a grommet connector in accordance with the present invention;

FIG. 5 is a perspective view of yet another embodiment of a grommet connector in accordance with the present invention;

FIG. 6 is a cross-sectional view of the grommet connector shown in FIGS. I and 2;

FIG. 7 is a perspective view of still another grommet connector in accordance with the present invention;

FIG. 8 is a perspective view of a yet further embodiment of a grommet connector in accordance with the present invention; and

FIG. 9 is a perspective view of still another embodiment of a grommet connector in accordance with the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including” and “comprising” and variations thereof is meant to encompass the items listed thereafter and equivalents thereof, as well as additional items and equivalents thereof.

### DETAILED DESCRIPTION OF THE PREFERRED EMBODIMENT

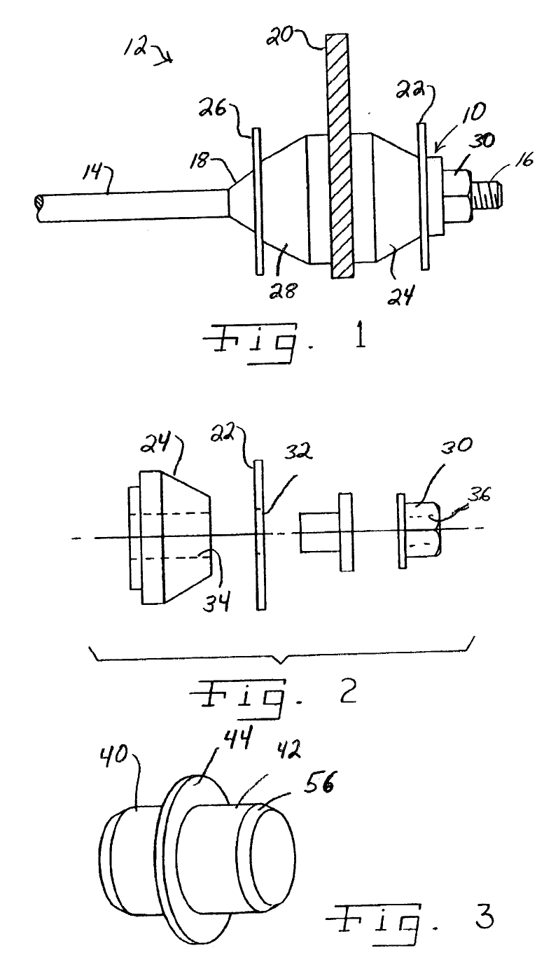

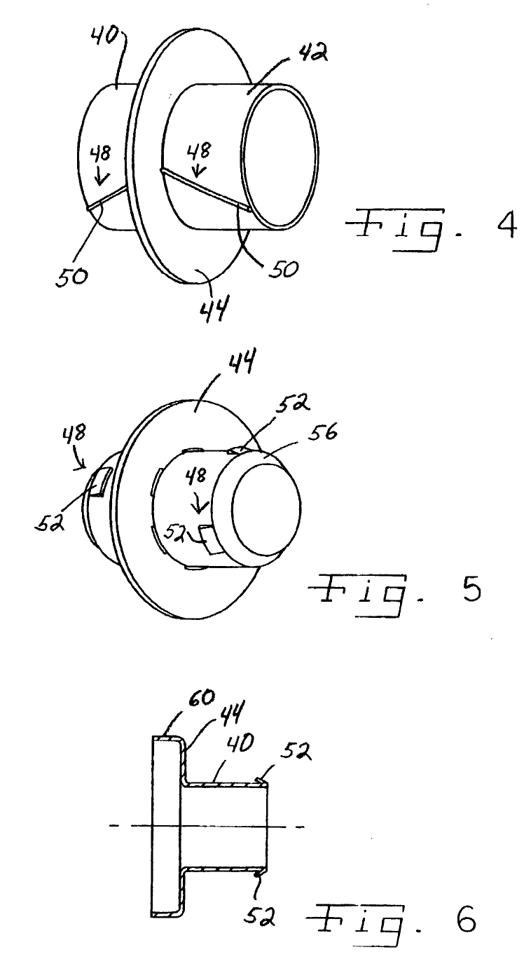

Referring now more specifically to the drawings and to FIG. 1 in particular, numeral 10 designates a grommet connector in accordance with the present invention shown within a tension strut mount assembly 12. It should be understood that grommet connectors in accordance with the present invention can be used in a variety of applications and installations. Strut mount assembly 12 shown and described herein is merely one advantageous application and use for grommet connectors of the present invention. Grommet connectors of the present invention can be used advantageously in vehicle suspension systems of types other than that shown, and/or in other assemblies using grommets of various types.

Tension strut mount assembly 12 includes a tension strut 14 having a threaded end 16. Strut 14 is a rod-like body having a collar 18 inwardly of threaded end 16. Tension strut 14 is connected to a suspension linkage member 20 and includes a washer 22 and a first grommet 24 on one side of linkage member 20 and a second washer 26 and second grommet 28 on the opposite side of linkage member 20. The assembly is secured against collar 18 by a nut 30 secured on threaded end 16 of strut 14. In the exemplary assembly shown, grommet connector 10 interconnects grommet 24, washer 22 and nut 30, such that holes 32., 34 and 36 in washer 22, grommet 24 and nut 30, respectively, are axially aligned with each other for placement on strut 14.

It should be understood that a grommet connector of the present invention can be used for connecting grommet 24 to other parts of other assemblies. For example, grommet connector 10 can be used to connect a grommet to a nut without a washer or can be used to connect two grommets together. In that regard, the structure and arrangement of grommet connector 10 can be varied as necessary for connecting to the various parts to be interconnected therewith.

Grommet connector 10 includes a first end portion 40 and a second end portion 42 which are axially aligned with each other and adapted to be connected to the selected parts of the assembly. First end portion 40 is adapted for connecting to grommet 24, and second end portion 42 is adapted for connecting to another part such as, for example, nut 30. A barrier 44 separates first end portion 40 from second end portion 42 and extends radially outward therefrom. Barrier 44 is of sufficient size such that grommet connector 10 can not be forced completely into holes 32, 34 or 36. Although barrier 44 is shown as comprising a radially extending flange having a diameter of appropriate size, barrier 44 can be of different shapes and sizes or even different structure, such as barbs or the like, so long as it is configured and arranged to prevent the grommet connector from being forced completely into the associated holes. Grommet connector 10 can be made of different materials, including various plastics and metals.

First end portion 40 is adapted for connecting grommet connector 10 to grommet 24. In a preferred embodiment of grommet connector 10, first end portion 40 is a barrel-like structure that is inserted into hole 34 of grommet 24. In that regard, barrel-like first end portion 40 can be of sufficient size to create a friction fit between first end portion 40 and grommet 24. First end portion 40 may include a tapered surface at the end thereof to facilitate insertion of first end portion 40 into hole 34 of grommet 24. To improve the engagement between first end portion 40 and grommet 24, a variety of surface formations 48 can be used on the outer surface of first end portion 40, to bind first end portion 40 in axial hole 34 of grommet 24. Surface formations 48 can include a rib or ribs 50 (FIG. 4) disposed at various angles on first end portion 40. Ribs 50 can be positioned on first end portion 40 axially, radially, helically or other as required. In other uses of grommet connector 10, formations 48 can be one or more barbs 52 (FIG. 5) angled outwardly toward barrier 44. Barbs 52 allow first end portion 40 to be inserted into hole 34 of grommet 24, but will embed into the grommet material defining hole 34 to resist pullout. In yet another variation, first end portion 40 can comprise a plurality of prongs 54 (FIG. 9) that can be inserted into grommet 24 just outwardly of hole 34. Still other structures for connecting first end portion 40 to grommet 24 include tongue and groove structures, interlocating fingers and other molded or formed features. Bonding also can be used.

Second end portion 42 is adapted to align with the other part to which grommet connector 10 is attached, such as, for example, nut 30, and thereby align grommet 24 with the other part. Second end portion 42 is further adapted for connecting grommet connector 10 to the other part, such as nut 30. In a simple form thereof, second end portion 42 can also be a barrel-like structure (FIG. 3) of sufficient size for insertion into the other part while providing a friction fit thereagainst. To facilitate insertion, second end portion 42 can be provided with a tapered surface 56 at the end thereof. The embodiment illustrated in FIG. 3, with first and second end portions 40 and 42 both being barrel-like structures, is suitable, for example, to connect together two grommets in end-to-end alignment. Alternatively, and to improve the engagement between grommet connector 10 and the other part, barrel-like second end portion 42 also can have one or more ribs 50 (FIG. 4), or one or more barbs 52 (FIG. 5). Instead of a barrel-like second end portion 42, prongs 54 can be provided, for insertion into the other part to be connected to grommet 24. Other features and structures described above for first end portion 40 can be used also for second end portion 42.

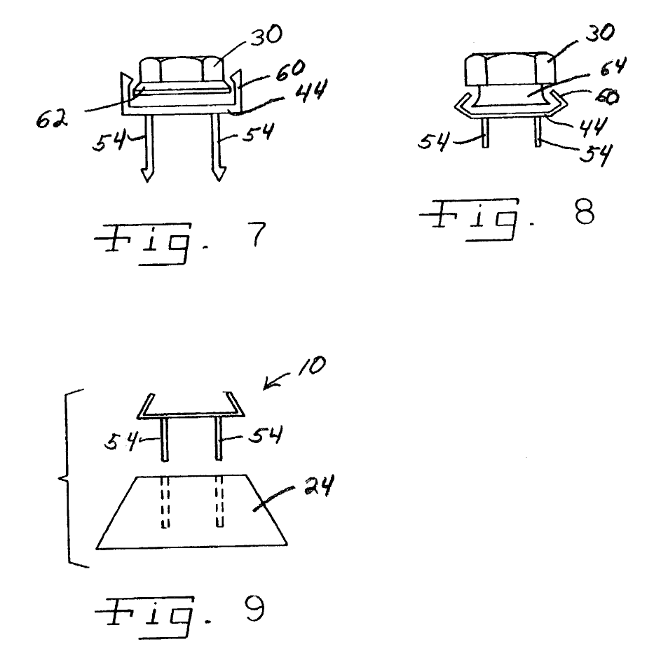

When grommet connector 10 is to be attached to a second part such as nut 30, a flange 60 is provided on barrier 44, to from a cup-like receiver adapted for engaging or receiving the other part. In that regard, flange 60 can be constructed and arranged for cooperation with an associated component. In one embodiment, such as that shown in FIG. 7, the grommet connector can be adapted for snap-fit cooperation with a rim 62 of nut 30. Grommet connector may be advantageously made of plastic material. If made of metal, however, the flange can be manipulated or formed or bent over rim 62 of nut 30 and, in one case, swaged thereagainst. FIG. 8 shows flange 60 engaging a skirt 64 of nut 30. Again, grommet connector can be made of various suitable materials and constructed and arranged to satisfy the features thereof. As yet another variation thereof, a relatively thin, barrel like second end portion 42 of soft plastic can be used and inserted into nut 30, against the threads thereof (not shown). As nut 30 is threaded on to threaded end 16 the threads of nut 30 and threaded end 16 cut through the soft material, making a self-locking threaded engagement of the parts.

Those skilled in the art will readily understand how grommet connector 10 can be used to connect a grommet 24 to other grommets, nuts or other parts. Washers, spacers or other components of various sizes can be assembled between barrier 44 and grommet 24 or between barrier 44 and the other part, such as nut 30. In this manner, two, three or more individual parts can be preassembled in proper order and axially aligned for efficient final assembly on strut 14. The properly assembled and aligned parts of the subassembly simplify the use of washers and other parts to extend durability and performance of the final assembly.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art. Various features of the invention are set forth in the following claims.

What is claimed is:

1. A connector for joining a grommet having an axial grommet hole therethrough to an other part having an axial other part hole therethrough, said connector comprising:
a body having a first end portion and a second end portion;
said first end portion adapted for connection to the grommet, said first end portion adapted for alignment with the hole of the grommet;
said second end portion adapted to align with the hole in the other part, said second end portion adapted for connecting said connector to the other part; and
a barrier disposed between said first end portion and said second end portion, said barrier comprising a radially extending flange having a diameter larger than the hole of the grommet and larger than the hole of the other part.

2. The connector of claim 1, said first end portion adapted for insertion into the grommet hole, and including exterior surface formations for engaging said grommet.

3. The connector of claim 2, said formations being barbs.

4. The connector of claim 2, said formations being annular rings.

5. The connector of claim 2, said formation being helical ribs.

6. The connector of claim 1, said second end portion including a flange for engaging an exterior surface of the other part.

7. The connector of claim 6, said second end portion including a flange being deformable to surround a portion of an exterior surface of the other part.

8. A grommet sub-assembly for a vehicle suspension system, comprising:
a grommet;
an other part; and
a grommet connector interconnecting said grommet and said other part, said grommet connector including:
a first end portion and a second end portion;
said first end portion adapted to engage said grommet and to axially align said connector with a hole in said grommet;
said second end portion adapted to engage said other part and to axially align said connector with a hole in said other part; and
a barrier disposed between said first end portion and said second end portion, said barrier comprising a radially extending flange.

9. The grommet subassembly of claim 8, said first end portion being an annular barrel received in said grommet hole, said barrel including exterior surface formations for engaging said grommet.

10. The grommet subassembly of claim 9, said formations being barbs.

11. The grommet subassembly of claim 9, said formations being annular rings.

12. The grommet subassembly of claim 9, said formations being helical ribs.

13. The grommet subassembly of claim 8, said second barrel end portion including a flange for engaging an exterior surface of said other part.

14. The grommet subassembly of claim 13, said second barrel end portion including a flange deformable to surround a portion of an exterior of said other part.

15. The grommet subassembly of claim 8, said other part being a second grommet.

16. The grommet subassembly of claim 8, said other part being a nut.

17. The grommet subassembly of claim 8, including a washer between said barrier and at least one of said grommet and said other part.

18. A grommet connector for connecting and aligning a grommet having a grommet hole with an other part having an other part hole, said grommet connector comprising:
a barrel-like first end portion adapted for insertion into the grommet hole and for engaging the material of grommet defining the grommet hole;
a said second end portion adapted to align with the hole in the other part and for connecting said connector to the other part; and
a barrier disposed between said first end portion and said second end portion, said barrier comprising a radially extending flange having a diameter larger than the hole of the grommet.

19. The grommet connector of claim 18, said first end portion including exterior surface formations for engaging said grommet.

20. The grommet connector of claim 18, said second end portion including a flange on said barrier forming a cup-like receiver for the other part.
